(19) United States
(12) Patent Application Publication
(10) Pub. No.: US 2026/0084101 A1
(43) Pub. Date: Mar. 26, 2026

(54) SYSTEMS AND METHODS FOR RECYCLING FLUID STREAMS DURING FLUID PURIFICATION

(71) Applicant: Archaea Energy Inc., Houston, TX (US)

(72) Inventors: Kevin Michael Weatherford, Angel Fire, NM (US); Michael John Mitariten, Pittstown, NJ (US); Stephen Jeffery Moore, Rosemount, MN (US)

(73) Assignee: Archaea Energy Inc., Houston, TX (US)

(21) Appl. No.: 19/334,547

(22) Filed: Sep. 19, 2025

Related U.S. Application Data
(60) Provisional application No. 63/697,217, filed on Sep. 20, 2024.

(51) Int. Cl. B01D 53/22; B01D 53/04

(52) U.S. Cl. CPC B01D 53/229; B01D 53/04; B01D 2053/221; B01D 2256/245; B01D 2257/104; B01D 2257/304; B01D 2257/504; B01D 2258/05

(57) ABSTRACT

A system, comprises: a regenerative unit configured to receive a compressed fluid stream and generate a treated fluid stream based on the compressed fluid stream; one or more membrane separation units configured to generate a methane-rich stream and a permeate recycle stream based on the treated fluid stream; and a volatile organic compounds (VOC) polishing bed configured to receive the permeate recycle stream and remove organic compounds from the permeate recycle stream to generate a VOC treated stream, wherein the system is configured to route the VOC treated stream from the VOC polishing bed downstream of the regenerative unit, and processes relating thereto.

### CROSS-REFERENCE TO RELATED APPLICATIONS

This application claims benefit of U.S. provisional patent application Ser. No. 63/697,217 filed Sep. 20, 2024, and entitled “Systems and Methods for Recycling Fluid Streams During Fluid Purification,” which is hereby incorporated herein by reference in its entirety for all purposes.

### STATEMENT REGARDING FEDERALLY SPONSORED RESEARCH OR DEVELOPMENT

Not applicable.

### TECHNICAL FIELD

The disclosure relates generally to purification and recyclability of fluid streams within a fluid purification system. More particularly, the disclosure relates to systems and methods for reducing demands on purification components of the fluid purification system through pressure control and recycling of fluid streams.

### BACKGROUND

Significant amounts of methane and carbon dioxide are generated during natural bacterial decomposition of organic materials within landfills, anaerobic digesters, waste water treatment plants, and the like. Fluids generated during natural bacterial decomposition generally contain methane, carbon dioxide, nitrogen, oxygen, water vapor, and small amounts (e.g., less than 1%) of hydrogen sulfide, volatile organic compounds (VOCs), hydrogen, and inorganic compounds. According to the Environmental Protection Agency, landfill gases release an estimated 119.8 metric tons of emissions into the atmosphere contributing to 14.4 percent of total U.S. methane emissions. Recovery of fluids generated during natural bacterial decomposition to produce renewable energy sources may be achieved via purification processes such as thermal swing adsorption (TSA) and pressure swing adsorption (PSA). Purification of such fluids produces methane-rich fluid streams that may be injected into natural gas streams. With the ever-increasing implementation of purification systems to treat such fluids, efficient and effective design, recyclability, and implementation of purification performance is challenging. As such, reducing demands on purification components of purification systems may improve efficiency and performance during generation of methane-rich product streams.

### SUMMARY

In some embodiments, a system, comprises: a regenerative unit configured to receive a compressed fluid stream and generate a treated fluid stream based on the compressed fluid stream; one or more membrane separation units configured to generate a methane-rich stream and a permeate recycle stream based on the treated fluid stream; and a volatile organic compounds (VOC) polishing bed configured to receive the permeate recycle stream and remove organic compounds from the permeate recycle stream to generate a VOC treated stream, wherein the system is configured to route the VOC treated stream from the VOC polishing bed downstream of the regenerative unit.

In some embodiments, a process for fluid purification, the process comprises: feeding a first feed stream into a first feed compression unit, wherein the first feed compression unit is configured to compress the first feed stream to a first pressure generating a first compressed feed stream; feeding the first compressed feed stream into a hydrogen sulfide removal unit configured to remove a portion of hydrogen sulfide from the first compressed feed stream and to generate a pretreated fluid stream; feeding the pretreated fluid stream into a second feed compression unit configured to receive the pretreated fluid stream and to generate a second compressed fluid stream at a second pressure; feeding the second compressed fluid stream into a regenerative unit configured to generate a waste gas stream and a treated fluid stream; feeding the treated fluid stream into a volatile organic carbons (VOC) polishing bed configured to generate a VOC treated stream; feeding the VOC treated stream into one or more membrane separation units configured to generate a methane-rich stream and one or more permeate recycle streams; and feeding one or more permeate recycle streams via, a flow path, to a position upstream of the VOC polishing bed and downstream of the regenerative unit.

In some embodiments, a system comprises: a first compression unit configured to receive a feed stream and to compress the feed stream to a first pressure, wherein the first pressure is between 10 and 100 psig; a hydrogen sulfide removal unit configured to receive the compressed feed stream and to generate a pretreated fluid stream; a second compression unit configured to receive the pretreated fluid stream and to compress the pretreated fluid stream to a second pressure that is greater than the first pressure; and a regenerative unit configured to receive the pretreated fluid stream compressed to the second pressure and generate a treated fluid stream.

In some embodiments, a system, comprises: a pretreatment subsystem configured to receive a methane-containing feed stream and generate a compressed pretreated stream based on the methane-containing feed stream; a regenerative adsorption subsystem configured to receive the compressed pretreated stream and generate a treated fluid stream based on the compressed pretreated stream; a separation subsystem configured to receive the treated fluid stream along a first flow path, and wherein the separation subsystem is configured to generate a permeate recycle stream and a methane-rich fluid based on the treated fluid stream; and a recycle subsystem configured to receive the permeate recycle stream, wherein the recycle subsystem comprises a second flow path that includes the permeate recycle stream and is directed into the first flow path at a position downstream of the regenerative adsorption subsystem with respect to the first flow path.

### BRIEF DESCRIPTION OF THE DRAWINGS

For a detailed description of various exemplary embodiments, reference will now be made to the accompanying drawings in which:

FIG. 1 is a schematic diagram of an embodiment of a fluid purification system, in accordance with an aspect of the present disclosure;

FIG. 2 is a flow diagram of a process related to an embodiment of the fluid purification system of FIG. 1, in accordance with an aspect of the present disclosure;

FIG. 3 is a schematic diagram of an embodiment of a fluid purification system including a hydrogen sulfide removal unit and a recycle subsystem, in accordance with an aspect of the present disclosure;

FIG. 4 is a flow diagram of a process related to an embodiment of the hydrogen sulfide removal unit of the fluid purification system of FIG. 3, in accordance with an aspect of the present disclosure;

FIG. 5 is a process diagram related to an embodiment of the recycle subsystem of the fluid purification system of FIG. 3, in accordance with an aspect of the present disclosure; and

FIG. 6 is a flow diagram of a process related to an embodiment of the recycle subsystem of the fluid purification system of FIG. 3 including a first membrane separation unit and a second membrane separation unit, in accordance with an aspect of the present disclosure.

### DETAILED DESCRIPTION

The following discussion is directed to various exemplary embodiments. However, one skilled in the art will understand that the examples disclosed herein have broad application, and that the discussion of any embodiment is meant only to be exemplary of that embodiment, and not intended to suggest that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in interest of clarity and conciseness.

In the following discussion and in the claims, the terms “including” and “comprising” are used in an open-ended fashion, and thus should be interpreted to mean “including, but not limited to . . . .” As used herein [symbol] the phrases “consist(s) of” and “consisting of” are used to refer to exclusive components of a composition [symbol] meaning only those expressly recited components are included in the composition; whereas the phrases “consist(s) essentially of” and “consisting essentially of” are used to refer to the primary components of a composition [symbol] meaning that only small or trace amounts of components other than the expressly recited components (e.g. [symbol] impurities [symbol] byproducts [symbol] etc.) may be included in the composition. For example [symbol] a composition consisting of X and Y refers to a composition that only includes X and Y [symbol] and thus [symbol] does not include any other components [symbol] and a composition consisting essentially of X and Y refers to a composition that primarily comprises X and Y [symbol] but may include small or trace amounts of components other than X and Y. In embodiments described herein [symbol] any such small or trace amounts of components other than those expressly recited following the phrase “consist(s) essentially of” or “consisting essentially of” preferably represent less than 5.0 wt % of the composition [symbol] more preferably less than 4.0 wt % of the composition [symbol] even more preferably less than 3.0 wt % of the composition [symbol] and still more preferably less than 1.0 wt % of the composition. Use of broader terms such as comprises, includes, having, etc. should be understood to provide support for narrower terms such as consisting of, consisting essentially of, comprised substantially of, etc. Use of the term “optionally” with respect to any element of a claim is intended to mean that the subject element is required, or alternatively, is not required. Both alternatives are intended to be within the scope of the claim. When introducing elements of various embodiments of the present disclosure, the articles “a,” “an,” and “the” are intended to mean that there are one or more of the elements.

The term “couple” or “couples” is intended to mean either an indirect or direct connection. Thus, if a first device couples to a second device, that connection may be through a direct engagement between the two devices, or through an indirect connection that is established via other devices, components, nodes, and connections. As used herein, the terms “approximately,” “about,” “substantially,” and the like mean are intended to convey that the value being described may be within a relatively small range of the property value, as those of ordinary skill would understand. In particular, the terms “approximately,” “about,” “substantially,” and the like mean within 10% (i.e., plus or minus 10%) of the recited value, within 5% (i.e., plus or minus 5%) of the recited value, or within 2% (i.e., plus or minus 2%) of the recited value.

Unless the context dictates the contrary, all ranges set forth herein should be interpreted as being inclusive of their endpoints, and open-ended ranges should be interpreted to include only commercially practical values. In addition, with respect to all ranges disclosed herein, such ranges are intended to include any combination of the mentioned upper and lower limits even if the particular combination is not specifically listed. All lists of values should be considered as inclusive of intermediate values unless the context indicates the contrary. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc. ; greater than 0.10 includes 0.11, 0.12, 0.13, etc.). As used herein, the term “regenerative unit” refers to one or more adsorbent beds configured to remove undesirable components from a fluid stream by preferentially binding the undesirable components at a specific temperature. It should be noted that the regenerative unit may be cycled between adsorption and desorption to selectively adsorb the undesirable components from a fluid stream. The regenerative unit may include a TSA unit, a PSA unit, or a combination thereof.

As used herein, the term “membrane separation stage” refers to one or more semi-permeable membranes configured to remove undesirable components from desirable components of a fluid stream by permitting the undesirable components to permeate a fiber of the one or more semi-permeable membranes based on molecular properties of the desirable components and collecting the undesirable components in a permeate stream. Desirable components do not pass through the semi-permeable membranes and may be directed to one or more subsequent purification stages.

As used herein, the phrase “based on” as related to a component generating a first fluid “based on” a second fluid, refers to the component generating the first fluid from the second fluid, but not solely from the second fluid. For example, the component may generate the first fluid using the second fluid and one or more additional streams (e.g., recycle streams). As another non-limiting example, an additional component may generate a third fluid from the second fluid, and the component may receive the third fluid from the additional component. In such an example, the component generates the first fluid based on the second fluid and/or the third fluid.

As used herein, a component that is “positioned along”, “positioned upstream”, and “positioned downstream” with respect to a flow path, indicates that the component receives a fluid along the flow path and/or provides, generate, or otherwise modifies a fluid along the flow path.

As used herein, a “flow path” refers to a conduit or route of one or more fluids. A flow path may be formed between multiple components. For example, a first component may provide a first fluid to a second component and the second component may generate a second fluid from the first fluid. As such, a flow path exists between the first component and the second component.

As briefly discussed above, fluid streams (e.g., biogas) generated from decomposing organic material may be purified to generate methane-rich product streams (e.g., renewable natural gas). Landfill sites, anaerobic digesters, waste water treatment plants, and other waste facilities (e.g., agricultural waste) may generate natural emissions during organic waste decomposition producing waste fluid streams for purification. Fluid purification systems may be designed to treat fluid streams. The fluid purification systems may include various purification stages to remove undesirable components (e.g., carbon dioxide, water vapor, hydrogen sulfide, volatile organic compounds (VOCs), trace inorganic compounds, and the like) from the fluid streams before injection into existing natural gas infrastructures. For example, oxygen and/or water vapor may be removed by thermal swing adsorption (TSA) units and/or pressure swing adsorption (PSA) units and output streams may be further purified using membrane separation units.

During removal of undesirable components from the fluid streams, various treated fluid streams and waste fluid streams may be generated. The treated fluid streams and waste fluid streams within fluid purification systems may be routed via fluid paths, fluid conduits, and the like. Efficient and effective design of fluid paths of fluid purification systems is challenging as various treated fluid streams may comprise reduced amounts of undesirable components but are not sufficiently pure to introduce into existing natural gas infrastructures. Conventional recycle processes of fluid purification systems direct recycle streams that are not sufficiently pure to an inlet of the fluid purification system at a same position as fluid streams from landfill sites or other waste sources are provided. Recycle streams may comprise between 30% and 60% of the inlet feed flow. As such, conventional recycle configurations increase a load on purification systems as equipment of each purification stage must be sized to handle the increased flow resulting from introduction of the recycle stream at the inlet. For example, an operational life of equipment of TSA units and/or PSA units may be reduced due to recycling solely to the inlet. Further, increased flow impacts operation and performance of purification stages due to decreased residence time as a result of the larger flow rate. Further, as a portion of undesirable components have been removed from recycle streams, recycle streams may be further purified by a subset of purifications stages provided by the purification system. Accordingly, there is a need to recycle treated streams to various positions within purification systems.

Additionally, improving design and operational control of fluid flow between and within purification stages may improve purification performance, increase operational efficiency, and reduce energy consumption of purification systems. For example, pressure drops may occur across various purifications stages due to operational limitations of equipment within the purification systems. Specifically, conventional removal of hydrogen sulfide from the waste fluid streams is limited to operations at low pressures. As such, fluids received after hydrogen sulfide removal may require significant compression to progress through subsequent purification stages increasing energy consumption. Accordingly, there is a need to reduce pressure drops across purification stages to improve efficiency and performance during generation of methane-rich product streams.

A fluid purification system is disclosed herein with improved recyclability of treated streams and efficiency during generation of a methane-rich product stream. The fluid purification system includes one or more purification subsystems (e.g., one or more purification substages) to facilitate removal of one or more undesirable components from a feed stream. The purification subsystems may include a pretreatment subsystem, a regenerative adsorption subsystem, a separation subsystem, a recycle subsystem, a flow control subsystem, one or more additional subsystems, or a combination thereof. The recycle subsystem of the fluid purification system controls recyclability of treated streams into various positions within the fluid purification system. The pretreatment subsystem of the fluid purification system includes a hydrogen sulfide removal unit configured to operate at sufficiently high pressures to reduce pressure drops across the fluid purification system during pretreatment. As such, the fluid purification system may integrate the recycle subsystem and/or the hydrogen sulfide removal unit to improve an efficiency of purifying the feed stream to produce a methane-rich product stream.

In some embodiments, the fluid purification system may receive the feed fluid such as a landfill fluid, a biogas, and/or one or more additional waste fluid streams for treatment. The fluid purification system may remove one or more undesirable components (e.g., fluids, organics, inorganics, and the like) from the feed fluid stream to generate a methane-rich product stream. The one or more purification subsystems of the fluid purification system may facilitate removal of the one or more undesirable components. Additionally, the fluid purification system may include a plurality of flow paths to fluidly couple the purification subsystems. In some embodiments, the flow paths may be fluidly coupled via a plurality of fluid conduits. The flow paths may include one or more waste streams, one or more product streams, one or more treated streams, one or more product streams, one or more permeate streams, one or more permeate recycle streams, or a combination thereof.

In some embodiments, the recycle subsystem of the fluid purification system may be used to direct recycle streams generated within different purification stages of the fluid purification system. For example, the regenerative adsorption subsystem may obtain and treat a pretreated stream to produce a treated fluid stream. The treated fluid stream may be substantially free of hydrogen sulfide, and water vapor. The treated fluid stream may be provided to one or more membrane separation units of the membrane separation stage. The membrane separation units may generate one or more permeate streams and one or more methane-rich product streams. The methane-rich product streams may be provided as output of the fluid purification system, sufficiently pure to introduce to additional downstream purification systems (e.g., PSA unit, cryogenic distillation) prior to injection into natural gas infrastructure. However, the permeate streams may include a substantial percentage of methane while also including undesirable components (e.g., carbon dioxide) above a threshold amount, preventing introduction to natural gas infrastructure. As such, the permeate streams may be provided to the recycle subsystem of the fluid purification system for further purification. One or more recycle permeate streams may be introduced downstream of the regenerative adsorption subsystem as the recycle permeate streams may be substantially free of hydrogen sulfide, and water vapor, and other contaminates. In some embodiments, the recycle permeate streams may be introduced to a VOC unit positioned upstream and/or downstream of one or more membrane separation units. In this manner, the recycle permeate streams may be purified by the VOC unit and sequentially reintroduced to the membrane separation units. In some embodiments, the recycle subsystem may include a permeate compression stage to compress the permeate recycle streams prior to receival by the VOC unit.

Embodiments of the present disclosure are also related to the utilization of the hydrogen sulfide removal unit of the pretreatment subsystem of the fluid purification system. The feed stream may be compressed at a first compression stage to generate a first compressed fluid stream, received at the hydrogen sulfide removal unit, treated by the hydrogen sulfide removal unit to generate a pretreated stream, further compressed at a second compression stage, and subsequently provided to the regenerative adsorption subsystem. In some embodiments, the first compressed fluid stream may be treated by the hydrogen sulfide removal unit at substantially high pressures such that the pretreated stream output by the hydrogen sulfide removal unit meets a threshold pressure. The threshold pressure may be based on minimizing a difference of a pressure of the first compressed fluid stream and a pressure of the second compressed fluid stream. Minimizing the difference in the first pressure and the second pressure may increase an efficiency of the fluid purification system by reducing a pressure drop across the purification subsystems. As such, the hydrogen sulfide unit may include one or more adsorption beds with controlled diameter beds and decreased amounts of adsorption media. For example, smaller diameter beds may provide a higher bed height to diameter ratio when compared to conventional adsorption beds improving adsorption media loading and flow characteristics. The hydrogen sulfide unit may be operated at increased pressures (e.g., approximately 25 psig) as compared to conventional operations (e.g., approximately 1 psig). In this way, the pressure drop across the purification subsystems may be reduced to increase operational efficiency.

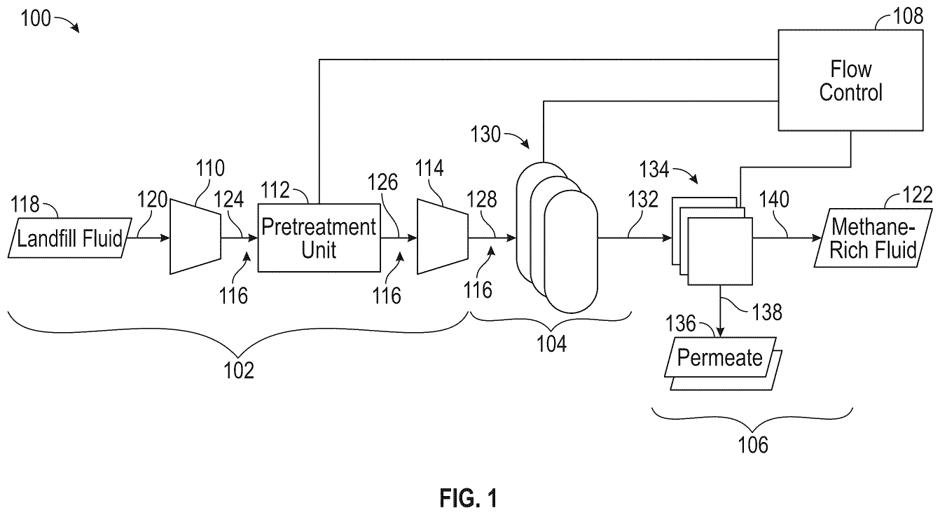

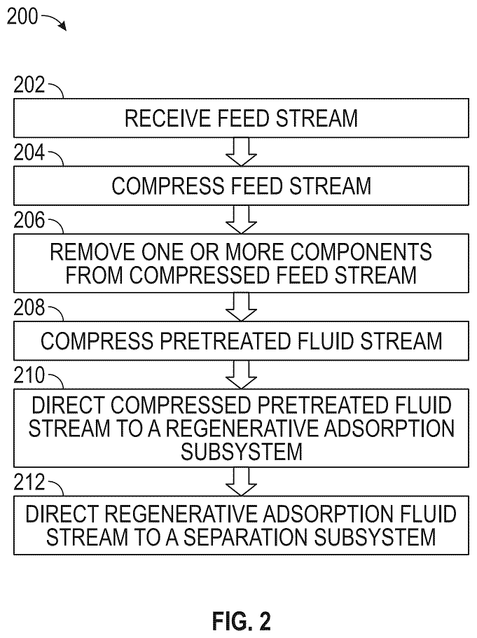

Turning now to the drawings, FIG. 1 illustrates an embodiment of a fluid purification system 100 (e.g., purification system) in accordance with the present disclosure. FIG. 2 illustrates a flow diagram of a process 200 related to an embodiment of the fluid purification system 100 of FIG. 1. To facilitate discussion, FIGS. 1 and 2 will be discussed below concurrently. It should be noted that the process 200 is not limiting, and the fluid purification system 100 and/or the process 200 may include additional or fewer steps than those illustrated. Further, the fluid purification system 100 and/or process 200 may include steps that are performed in an alternative order to that illustrated in process 200. That is, certain steps may be performed before, after, or concurrently to/with another respective step.

The fluid purification system 100 may include one or more purification subsystems. The purification subsystems may include a pretreatment subsystem 102, a regenerative adsorption subsystem 104, a separation subsystem 106, and a flow control subsystem 108. It should be noted that the fluid purification system 100 may include one or more additional subsystems such as a recycle subsystem. Additionally and/or alternatively, one or more subsystems of the fluid purification system 100 may be omitted. For example, the flow control subsystem 108 may be omitted from the fluid purification system 100. The pretreatment subsystem 102 may include a first compression stage 110, a pretreatment unit 112, a second compression stage 114, or a combination thereof. The pretreatment unit 112 may include a hydrogen sulfide removal unit (e.g., a fixed-bed, a regenerative bed, a lead-lag bed, and the like). The pretreatment unit may also include one or more filters, one or more separators, one or more dehydrators, one or more chillers, and the like.

The hydrogen sulfide removal unit can comprise any suitable unit for removing hydrogen sulfide in a hydrocarbon containing stream to a desired level. Any suitable structures can be used such as absorption towers (e.g., packed bed units, fixed bed units, fluidized or ebullient bed towers, or the like). Any suitable absorbent or adsorbent can be used. For example, amine absorbents can be used with an absorber and regenerator to remove the hydrogen sulfide. In some aspects, a hydrogen sulfide removal unit can comprise a solid media such as an iron sponge, activated carbon, molecular sieves, or the like to adsorb the hydrogen sulfide in a regenerative or non-regenerative manner.

The regenerative adsorption subsystem 104 may include one or more regenerative adsorption beds, one or more regenerative adsorption columns, a heating system, a cooling system, one or more switching valves, one or more heat exchangers, or a combination thereof. The separation subsystem 106 may include one or more VOC adsorption beds, one or more membrane separation stages, one or more heat exchanges, and the like. The flow control subsystem 108 may include one or more controllers, one or more sensors, one or more manifolds, and the like. The flow control subsystem 108 may control one or more flowrates of one or more produced fluids of the fluid purification system 100. For example, the controllers may provide instructions to the flow control subsystem 108 to vary the flowrates and ratios of produced fluids to the one or more subsystems of the fluid purification system 100 to account for fluid composition, pressure, temperature, operational efficiency, or any combination thereof. In certain embodiments, the controllers may continuously vary the flowrates and ratios of the produced fluids to the manifolds in real-time to maintain the desired flow rates within upper and lower thresholds.

The fluid purification system 100 may include one or more fluid paths 116. The fluid paths 116 may be configured to direct fluids through the purification subsystems of the fluid purification system 100. A landfill fluid 118 may be directed into the fluid purification system 100 as a feed stream 120 for processing (e.g., purification) into a methane-rich fluid 122. The landfill fluid 118 exiting a landfill or entering the fluid purification system 100 may include a methane volume percentage in the range of 30% and 75%, but more typically in the range of 45% and 60%.

At block 202, the first compression stage 110 receives the feed stream 120. For example, the feed stream 120 may be directed towards, fed, or otherwise provided, into the first compression stage 110 of the pretreatment subsystem 102. The first compression stage 110 may include one or more coolers (e.g., air coolers, oil coolers) and/or one or more compressors configured to compress the feed stream 120. In some embodiments, the first compression stage 110 may include one or more compressors in parallel. At block 204, the feed stream 120 is compressed, producing a compressed feed stream 124. The compressed feed stream 124 may be compressed to a predetermined pressure. The predetermined pressure may be based on an operational pressure of the pretreatment unit 112. The compressed feed stream 124 may be directed to the pretreatment unit 112. At block 206 of the process 200, the fluid purification system 100 may remove one or more components from the compressed feed stream 124. In some embodiments, the pretreatment unit 112 may be a hydrogen sulfide removal unit. As such, the pretreatment unit 112 may produce a pretreated fluid stream 126. The pretreated fluid stream 126 may include a reduced percentage of the one or more components that may include hydrogen sulfide.

At block 208 of the process 200, the fluid purification system 100 may compress the pretreated fluid stream 126. For example, the pretreated fluid stream 126 may be compressed by the second compression stage 114. The second compression stage 114 may include one or more coolers (e.g., air coolers, oil coolers) and/or one or more compressors. In some embodiments, the second compression stage 114 may include one or more compressors in parallel. The second compression stage 114 may be controlled via the flow control subsystem 108 to compress the pretreated fluid stream 126 to a second pressure, generating a compressed pretreated fluid stream 128. The second pressure may be based on an operational pressure of the regenerative adsorption subsystem 104. It should be noted, that in some embodiments, pressures of the fluid purification system 100 may be controlled based on design of the fluid purification system 100. That is, the fluid purification system 100 may not include the flow control subsystem 108 and may be designed to operate at a series of set pressures. At block 210 of process 200, the fluid purification system 100 may direct the compressed pretreated fluid stream 128 to the regenerative adsorption subsystem 104. In some embodiments, the regenerative adsorption subsystem 104 may remove undesirable components from the compressed pretreated fluid stream 128 using one or more regenerative beds 130. As such, the regenerative adsorption subsystem 104 may generate a treated fluid stream 132.

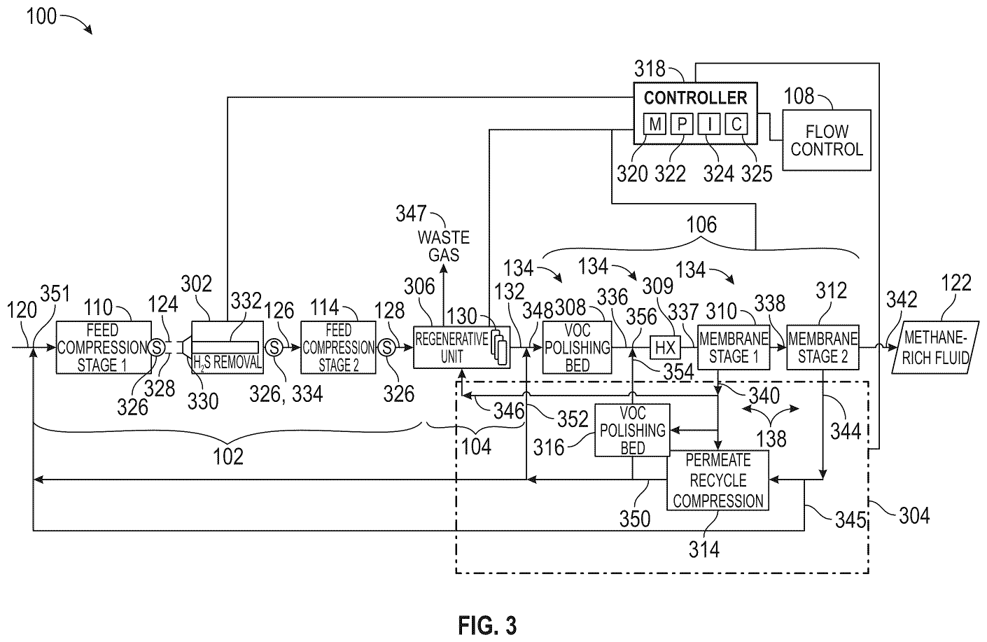

At block 212 of the process 200, the fluid purification system 100 may direct the treated fluid stream 132 to the separation subsystem 106. In some embodiments, the treated fluid stream 132 may be directed to one or more separation units 134. The one or more separation units 134 may include a VOC polishing bed, one or more heat exchangers, one or more membrane units, or a combination thereof. The separation subsystem 106 may generate one or more permeate fluids 136 via one or more permeate streams 138. For example, the permeate fluids 136 may have a molar composition including approximately 30% methane, 18% nitrogen, 48% carbon dioxide, 2% oxygen, and 2% of one or more additional components. Further, the separation subsystem 106 may generate the methane-rich fluid 122 via a methane-rich stream 140. The methane-rich fluid 122 may be used for one or more applications. The applications may include providing the methane-rich fluid 122 to additional downstream purification systems (e.g., PSA unit, cryogenic distillation) prior to injection into a natural gas pipeline. The permeate fluids 136 may be recycled via a recycle unit via one or more additional fluid paths as will be discussed further with regards to FIG. 3.

FIG. 3 is a schematic diagram of an embodiment of a fluid purification system 100 including a hydrogen sulfide removal unit 302 and a recycle subsystem 304, in accordance with an aspect of the present disclosure. As shown, one or more purification subsystems may be included in the fluid purification system 100. It should be noted, that the illustrated management purification subsystems are provided as examples and more, fewer, or different purification subsystems may be included in the fluid purification system 100. As shown, the purification subsystems encompassed in the fluid purification system 100 may include a pretreatment subsystem 102, a regenerative adsorption subsystem 104, a separation subsystem 106, a flow control subsystem 108, and the recycle subsystem 304. The pretreatment subsystem 102 may include the first compression stage 110, the hydrogen sulfide removal unit 302, and the second compression stage 114. The regenerative adsorption subsystem 104 may include a regenerative unit 306 (e.g., TSA unit, PSA unit) with one or more regenerative beds 130. The separation subsystem 106 may include one or more separation units 134. The separation units 134 may include a VOC polishing bed 308, a heat exchanger 309, a first membrane separation unit 310, a second membrane separation unit 312, or a combination thereof. The recycle subsystem 304 may include a recycle compression stage 314, a recycle VOC polishing bed 316, and/or additional components.

In some embodiments, a TSA unit may be used. The TSA unit can include two or more adsorber beds including activated carbon or a zeolite adsorbent, and a regeneration heater utilizing a heated purge gas or steam. For example, the one or more adsorbent beds of the TSA system may operate in parallel and undergo different cycles including adsorption, depressurization, heating, cooling, and repressurization. For example, the TSA system may utilize two or more adsorbent beds, three or more adsorbent beds, four or more adsorbent beds, etc. Accordingly, the embodiments described herein enable treating an incoming gas stream to generate a treated gas stream that is substantially lower in contaminants relative to the incoming gas stream.

In some embodiments, the first membrane separation unit 310 and the second membrane separation unit 312 can, independently, utilize any suitable polymeric membrane, such as a polyimide, a polysulfone, a polyetherimide, a cellulose acetate, a polybenzimidazole, or a combination thereof, for separating carbon dioxide and oxygen from methane. Each membrane separation stage refers to one or more semi-permeable membranes configured to remove undesirable components from desirable components of a fluid stream by permitting the desirable components to pass through the one or more semi-permeable membranes based on molecular properties of the desirable components. Desirable components do not pass through the semi-permeable membranes and may be directed to one or more subsequent purification stages. The retentate from the membrane separator 50 can comprise the majority of the methane, which can then pass as stream 52 to the cryogenic separator 100.

In some embodiments, the VOC polishing bed 308, or hydrocarbon polishing bed, can act as an “oil catch” to remove volatile organic compounds (VOCs) and/or heavy hydrocarbons (e.g., C₆⁺) and may include a non-regenerable bed having, e.g., an activated carbon, a molecular sieve, a silica gel, an alumina, or an ion exchange resin, to remove residual contaminants from an incoming gas stream.

The fluid purification system 100 may include a controller 318. The controller 318 may include a memory 320, a processor 322, instructions 324, and communication circuitry 325 configured to communicate with sensors and various equipment of the fluid purification system 100. For example, the controller 318 may be configured to receive sensor feedback from one or more sensors 326 coupled to the pretreatment subsystem 102, the regenerative adsorption subsystem 104, the separation subsystem 106, the flow control subsystem 108, the recycle subsystem 304, and/or additional components of the fluid purification system 100 and control said equipment based on sensor feedback data, operating modes, user inputs, computer models, or any combination thereof. The controller 318 may be communicatively coupled to various components, actuators, and sensors of the fluid purification system 100.

In some embodiments, the feed stream 120 may be provided to the first compression stage 110 of the pretreatment subsystem 102. The first compression stage 110 may compress the feed stream 120 to generate a compressed feed stream 124. The compressed feed stream 124 may be directed to the hydrogen sulfide removal unit 302 via a conduit 328. The conduit 328 may be fluidly coupled to an inlet 330 of the hydrogen sulfide removal unit 302. The inlet 330 may be approximately 30.5 cm (12 inches) in diameter. In some embodiments, the flow control subsystem 108 of the fluid purification system 100 may control the first compression stage 110 to compress the compressed feed stream 124 to a first pressure such that the inlet 330 of the hydrogen sulfide removal unit 302 may receive the compressed feed stream 124 at the first pressure. In some embodiments, the first pressure may be approximately 25 psig. In other embodiments, the first pressure may range between 10 and 100 psig, 10 and 50 psig, 25 and 100 psig, 15 and 25 psig, or 20 and 75 psig. The first pressure may be set based on a predetermined pressure selected to minimize a pressure drop across the pretreatment subsystem 102, reducing energy consumption of the fluid purification system 100. The hydrogen sulfide removal unit 302 may include a non-regenerative adsorption bed 332 (e.g., having a non-regenerative adsorption media). The non-regenerative adsorption bed 332 may include adsorption media (e.g., activated carbon, iron oxide, zinc oxide, magnesium oxide, mixed metal oxy-hydroxide, and like) disposed in a vessel as described herein. As the compressed feed stream contacts the adsorbent, the hydrogen sulfide can adsorb and be retained by the adsorbent to produce a compressed feed stream having a reduced hydrogen sulfide content. The hydrogen sulfide removal unit 302 may be configured to increase a loading capacity (e.g., ratio of adsorbate to adsorbent) of the fluid purification system 100. The loading capacity may be based on a length and a height of the non-regenerative adsorption bed 332. For example, the hydrogen sulfide removal unit 302 may include non-regenerative adsorption beds of with adsorbent length to adsorbent height ratios greater than approximately 2. As such, operating the hydrogen sulfide removal unit 302 at approximately 25 psig may increase a throughput of the compressed feed stream 124 through the non-regenerative adsorption bed 332. In this way, the hydrogen sulfide removal unit 302 may remove hydrogen sulfide from the compressed feed stream 124 using less power as compared to hydrogen sulfide removal units operating at lower pressures (e.g., approximately 1 psig).

In some embodiments, the hydrogen sulfide removal unit 302 may generate a pretreated fluid stream 126. The pretreated fluid stream 126 may have a reduced concentration (e.g., percentage) of hydrogen sulfide relative to the compressed feed stream 124. The pretreated fluid stream 126 may be directed to the second compression stage 114 comprising one or more compressors arranged in series or parallel. The second compression stage 114 may compress the pretreated fluid stream 126, generating a compressed pretreated fluid stream 128. The compressed pretreated fluid stream 128 may be compressed to a second pressure. The controller 318 may receive sensor data from a first sensor 334. As such, the flow control subsystem 108 may determine the second pressure based on suction control of the second compression stage 114 to compress the pretreated fluid stream 126 to the second pressure. The second pressure may be based on membrane performance with a set minimum threshold pressure to avoid fluidization. For example, the controller 318 may compare the first pressure, the second pressure, and a third pressure of the compressed pretreated fluid stream 128 exiting the second compression stage 114. In some embodiments, the hydrogen sulfide removal unit 302 is installed in a position within the pretreatment subsystem 102 to reduce the pressure drop across the pretreatment subsystem 102. As such, optimization of the position of the hydrogen sulfide removal unit 302, described herein, may reduce power consumption of the pretreatment subsystem 102. In some embodiments, the controller 318 may decrease the pressure drop across the pretreatment subsystem 102 by minimizing the difference of the first pressure, the second pressure, and the third pressure while maintaining pressures within the operational pressure of the hydrogen sulfide removal unit 302 and the regenerative adsorption subsystem 104. It should be noted, that in some embodiments the controller 318 of the fluid purification system 100 may be omitted. That is, the fluid purification system 100 may be designed to operate at the first pressure, the second pressure, and the third pressure based on design of the fluid purification system 100.

In some embodiments, the compressed pretreated fluid stream 128 may be directed to a regenerative unit 306 (e.g., TSA unit, PSA unit) of the regenerative adsorption subsystem 104. The regenerative unit 306 may remove undesirable components (e.g., water, VOCs, non-methane organic compounds, and the like) from the compressed pretreated fluid stream 128 using one or more regenerative adsorption beds. As such, the regenerative adsorption subsystem 104 may generate a treated fluid stream 132. The treated fluid stream 132 may be output by the fluid purification system 100 to the separation subsystem 106. In some embodiments, the treated fluid stream 132 may be received by the VOC polishing bed 308. The VOC polishing bed 308 may remove hydrocarbons (e.g., oil, condenser oils), alcohols, amines, ethers, and the like. In some embodiments, the VOC polishing bed 308 may remove siloxanes and additional non-methane containing organic compounds. The VOC polishing bed 308 may output a VOC treated stream 336 to the heat exchanger 309. The heat exchanger 309 may include an indirect heat exchanger, such as a shell and tube heat exchanger, a coiled tube heat exchanger, a plate heat exchanger, a double tube heat exchanger, an electric heater, or any combination thereof. The heat exchanger 309 may generate a heated VOC treated stream 337. The heat exchanger 309 may output the heated VOC treated stream 337 to the first membrane separation unit 310. The first membrane separation unit 310 may remove carbon dioxide, oxygen, or a combination there of from the heated VOC treated stream 337 generating a first methane-rich stream 338 and a first permeate stream 340 (e.g., a first permeate recycle stream). The first permeate recycle stream 340 may include approximately 95% carbon dioxide. As such, the first permeate recycle stream 340 may be directed to the regenerative adsorption subsystem 104 via a regeneration stream 346. The regeneration stream 346 may be used to regenerate the regenerative unit 306. Regeneration of the regenerative unit 306 may be performed using the regeneration stream 346 at a low pressure (e.g., approximately 2 psig). It should be noted, in some embodiments, the fluid purification system 100 may direct the first permeate stream 340 to a thermal oxidizer for destruction. Additionally and/or alternatively, the first permeate recycle stream 340 may be directed to the recycle subsystem 304. In some embodiments, the first permeate recycle stream 340 may be recycled to one or more additional processing stages to capture the carbon dioxide for industrial applications.

In some embodiments, the first methane-rich stream 338 may be directed to the second membrane separation unit 312. Additional separation of undesirable components may be performed by the second membrane separation unit 312 to generate a second methane-rich stream 342 and a second permeate stream 344 (e.g., a second permeate recycle stream). The second methane-rich stream 342 may be output as the methane-rich fluid 122. The methane-rich fluid 122 may be directed to one or more additional purification steps prior to use in one or more natural gas applications. In some embodiments, the second permeate recycle stream 344 may be directed to a reintroduction stream 345. The reintroduction stream 345 may introduce the second permeate recycle stream 344 into the feed stream 120 at a position 351. In some embodiments, the second permeate recycle stream 344 may be directed to the recycle subsystem 304.

In some embodiments, the recycle subsystem 304 may receive one or more permeate streams 138 that may include the first permeate recycle stream 340, the second permeate recycle stream 344, or a combination thereof. The first permeate recycle stream 340 may be directed to the regenerative adsorption subsystem 104 via a regeneration stream 346. The regeneration stream 346 may be used to regenerate the regenerative beds 130 of the regenerative unit 306. For example, the regeneration stream 346 may be provided to the regenerative unit 306 at a high temperature to regenerate the one or more regenerative beds 130 by desorbing the undesirable components. Regeneration of the regenerative unit 306 may generate a waste gas 347. The waste gas 347 may be flared, combusted, or further processed in one or more additional subsystems of the fluid purification system.

In some embodiments, the first permeate recycle stream 340 may be received by the permeate recycle compression stage 314 (e.g., including at least one compressor), the recycle VOC polishing bed 316, or a combination thereof. In some embodiments, the second permeate recycle stream 344 may be directed to the permeate recycle compression stage 314. The permeate recycle compression stage 314 may generate a compressed permeate stream 350. The compressed permeate stream 350 may be directed to a position 351 upstream of the pretreatment subsystem 102. In this manner, the compressed permeate stream 350 or a portion of the compressed permeate stream 350 may be combined with the feed stream 120.

In some embodiments, the compressed permeate stream 350 may be directed to a position 348 upstream of the VOC polishing bed 308 and downstream of the regenerative unit 306 via a permeate bypass stream 352. The compressed permeate stream 350 may be substantially free of undesirable components (hydrogen sulfide, water vapor) yet may not be sufficiently pure as compared to the methane-rich fluid 122. As such, the permeate bypass stream 352 (e.g., recycle permeate stream) may be introduced to the VOC polishing bed 308 positioned upstream of the first and second membrane separation units 310, 312. In this manner, the permeate bypass stream 352 may be further purified by the VOC polishing bed 308 and sequentially reintroduced to the first and second membrane separation units 310, 312. Introduction of the permeate bypass stream 352 downstream of the regenerative unit 306 may reduce a stress on equipment of the pretreatment subsystem 102 and the regenerative adsorption subsystem 104. For example, the compressed permeate stream 350 may include a level of hydrogen sulfide below a target threshold. As such, bypass of the hydrogen sulfide removal unit 302 may improve performance of the fluid purification system 100. The permeate bypass stream 352 may have a pressure different from a pressure of the feed stream 120 as the flow control subsystem 108 may independently control pressure of the compressed permeate stream 350. Increased granularity of pressure control may improve operational and energy efficiency of the fluid purification system 100. For example, the recycle compression stage 314 may generate the compressed permeate stream 350 with a pressure ranging between about 1 psig to 180 psig whereas the feed stream 120 may have a pressure of approximately −2.2 psig.

Additionally and/or alternatively, introduction of the compressed permeate stream 350 downstream of the regenerative unit 306 via the permeate bypass stream 352 may improve performance of the regenerative unit 306 by providing longer residence times within the regenerative beds 130. When the one or more permeate streams 138 (e.g., such as the compressed permeate stream 350) are combined with the feed stream 120 the flow rate of the compressed pretreated fluid stream 128 may increase, decreasing the residence time within the regenerative beds 130 during generation of the treated fluid stream 132. As such, introduction of the compressed permeate stream 350 at the position 348 downstream of the regenerative unit 306 via the permeate bypass stream 352 may improve operational efficiency and lifetime of the regenerative unit 306 by increasing residence time. Further, introduction of the compressed permeate stream 350 at the position 348 downstream of the regenerative unit 306 via the permeate bypass stream 352 may decrease a total amount of VOC within the regenerative unit 306 and the first and second membrane separation unit 310, 312 increasing a lifetime of the VOC polishing bed 308. As such, the compressed permeate stream 350 or a portion of the compressed permeate stream 350 may be received by the VOC polishing bed 380 in addition to or instead of the treated fluid stream 132.

In some embodiments, the recycle subsystem 304 may direct the compressed permeate stream 350 to the recycle VOC polishing bed 316 to generate a recycle VOC treated stream 354. The recycle VOC polishing bed 316 may be used to remove hydrocarbons (e.g., oils, compressor oils), alcohols, amines, ethers, and other organic compounds from the compressed permeate stream 350. The recycle VOC treated stream 354 may be introduced at a position 356 upstream of the first membrane separation unit 310 and downstream of the VOC polishing bed 308. In some embodiments, use of the recycle VOC polishing bed 316 may reduce a load of the VOC polishing bed 308, increasing operational lifetime. Additionally and/or alternatively, the recycle VOC polishing bed 316 may increase productivity of the fluid purification system 100 by increasing a rate of production of the first methane-rich stream 338 by providing the recycle VOC treated stream 354 to the first membrane separation unit 310. It should be noted, that in some embodiments the position 356 may be omitted from the fluid purification system 100.

In some embodiments, the controller 318 may control the flow control subsystem 108 to control the recycle subsystem 304 to provide the one or more permeate streams (e.g., the first permeate recycle stream 340, the second permeate recycle stream 344) to a combination of the pretreatment subsystem 102, the regenerative adsorption subsystem 104, and/or the separation subsystem 106. For example, the controller 318 may send a signal to the recycle subsystem 304 to selectively partition a percentage (e.g., percentage of the mass flow rate) of the compressed permeate stream 350 into the recycle VOC polishing bed 316 and a percentage into a thermal oxidizer. The flare stream may be destroyed via the thermal oxidizer. The thermal oxidizer may include an elevated stack and may be used to combust the portion of the first flow path. The thermal oxidizer. The controller 318 of the fluid purification system 100 may regulate a flow rate of the permeate stream 350 and the flare stream. In some embodiments, the controller 318 may control flow of the first permeate recycle stream 340 to the regenerative adsorption subsystem 104 and the second permeate recycle stream 344 to the position 348 upstream of the VOC polishing bed 308 and downstream of the regenerative unit 306. It should be noted, that in some embodiments the compressed permeate stream 350 may only be introduced downstream of the regenerative unit 306. That is, in some embodiments, the position 351 may be omitted from the fluid purification system 100.

Accordingly, FIG. 3 shows multiple flow paths with the fluid purification system 100. For example, the pretreatment subsystem 102 includes a first flow path formed by the feed stream 120, the compressed feed stream 124, the pretreated fluid stream 126, and the compressed pretreated fluid stream 128. Further, the separation subsystem 106 includes a second flow path formed by the treated fluid stream 132, the VOC treated stream 336, the heated VOC treated stream 337, the first methane-rich stream 338, and the second methane-rich stream 342. The regenerative adsorption subsystem 104 fluidly couples the first flow path to the second flow path.

Further, the recycle subsystem 304 includes a first recycle flow path formed by the second permeate recycle stream 344, the compressed permeate stream 350, and the recycle VOC treated stream 354. The first recycle flow path fluidly couples the second membrane separation unit 312 to the position 356. The recycle subsystem 304 includes a second recycle flow path formed by the first permeate recycle stream 340, the compressed permeate stream 350, and the recycle VOC treated stream 354. The second recycle flow path fluidly couples the first membrane separation unit 310 to the position 356. The recycle subsystem 304 includes a third recycle flow path formed by the first permeate recycle stream 340, the compressed permeate stream 350, and the permeate bypass stream 352. The third recycle flow path fluidly couples the first membrane separation unit 310 to the position 348. The recycle subsystem 304 includes a fourth recycle flow path formed by the second permeate recycle stream 344, the compressed permeate stream 350, and the permeate bypass stream 352. The fourth recycle flow path fluidly couples the second membrane separation unit 312 to the position 348. It should be noted that the above-mentioned flow paths are not meant to be limiting, and FIG. 3 may include other flow paths than those explicitly discussed above. It should be noted, that a portion of the above-mentioned flow paths may be directed to a thermal oxidizer at one or more points within the fluid purification system 100. For example, a portion of the first flow path formed by the feed stream 120, the compressed feed stream 124, the pretreated fluid stream 126, and the compressed pretreated fluid stream 128 may be directed to the thermal oxidizer. The thermal oxidizer may include an elevated stack and may be used to destroy the portion of the first flow path through combustion.

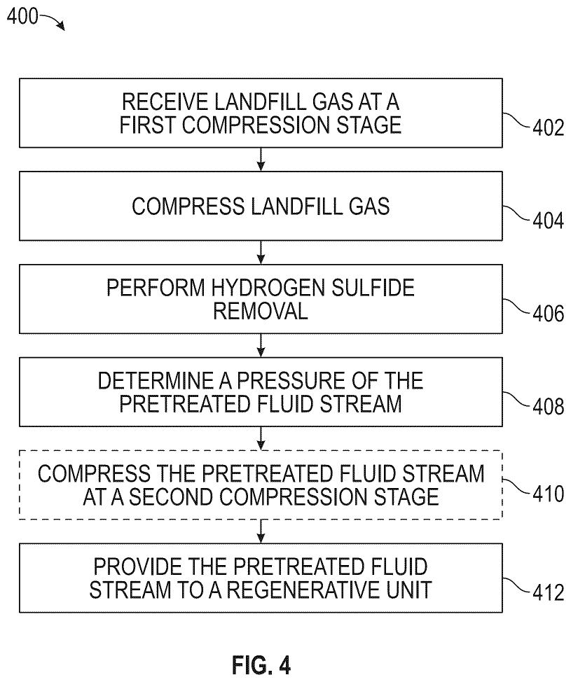

FIG. 4 is a flow diagram of a process 400 related to an embodiment of the hydrogen sulfide removal unit 302 of the fluid purification system 100 of FIG. 3, in accordance with an aspect of the present disclosure. The process 400 may be performed by a computing device, a controller, or any other suitable computing device(s) or controller(s). Furthermore, the blocks of the process 400 may be performed in the order disclosed herein or in any suitable order. For example, certain blocks of the process may be performed concurrently. In addition, in certain embodiments, at least one of the blocks of the process 400 may be omitted.

At block 402 of the process 400, the fluid purification system 100 may receive landfill gas at a first compression stage 110. The landfill gas may be captured from a landfill site using one or more blowers, one or more wells, or a combination thereof. The landfill gas may be received by the first compression stage 110 as a feed stream 120. At block 404 of the process 400, the fluid purification system 100 may compress the landfill gas. Compression of the landfill gas may be based on an operational pressure of one or more pieces of equipment downstream of the first compression stage 110. The first compression stage 110 may operate in a suction pressure control mode to control an inlet pressure of the landfill gas. In some embodiments, the landfill gas may be collected by controlling vacuum on a wellfield. The inlet pressure may range from approximately −5 psig to 0 psig. In other embodiments, the landfill gas may be collected by receiving the landfill gas from a blower. The inlet pressure may be range from approximately 0 psig to 10 psig when receiving the landfill gas from the blower. The landfill gas may be compressed from the inlet pressure of the first compression stage 110 to a first pressure within an operational pressure range of a hydrogen sulfide removal unit 302. For example, the first pressure may range between 25 psig and 50 psig, 25 psig and 45 psig, 25 psig and 30 psig. The first pressure may be greater than approximately 25 psig. The hydrogen sulfide removal unit 302 may include relatively small diameter beds that may operate at relatively high pressures (e.g., approximately 25 psig). For example, the hydrogen sulfide removal unit 302 may include non-regenerative adsorption beds of with adsorbent length to adsorbent height ratios greater than approximately 2. Operation of the hydrogen sulfide removal unit 302 at relatively high pressures may reduce a pressure drop across the fluid purification system 100. The pressure drop may be approximately 0.5%, approximately 0.3%, or approximately 0.2%. Further, use of relatively small diameter beds may reduce an amount of media needed for packing while increasing media loading and utilization due to improved flow characteristics (e.g., increased height to diameter ratio).

At block 406 of the process 400, the fluid purification system 100 may perform hydrogen sulfide removal. The hydrogen sulfide removal may be performed by the hydrogen sulfide removal unit 302 to generate a pretreated fluid stream 126. At block 408, the fluid purification system 100 may determine a pressure of the pretreated fluid stream 126. The pressure may be determined using the one or more sensors 326. The sensors 326 may include an absolute pressure sensor, a gauge pressure sensor, a differential pressure sensor, or a combination thereof. The controller 318 of the fluid purification system 100 may receive data from the sensor 326 to determine the pressure of the pretreated fluid stream 126. It should be noted, that in some embodiments the fluid purification system 100 may be operated at a series of set pressures determined during design of the fluid purification system 100. As such, the controller 318 and sensors 326 may be omitted from the fluid purification system 100. As such, the pressure of the pretreated fluid stream 126 may be preset. The pressure of the pretreated fluid stream 126 may range between 15 psig and 35 psig, 20 psig and 30 psig, 25 psig and 30 psig. The first pressure may be approximately 25 psig.

At block 410 of the process 400, the fluid purification system 100 may optionally compress the pretreated fluid stream 126 at a second compression stage 114. The second compression stage 114 may operate in a suction pressure control mode to control an inlet pressure of the pretreated fluid stream 126. The inlet pressure may be set to a set point of approximately 25 psig. As such, the inlet pressure of the pretreated fluid stream 126 may be regulated to not exceed the set point. In some embodiments, the second compression stage 114 may compress the pretreated fluid stream 126 to a compressed pressure based on an operational range of the regenerative unit 306. In some embodiments, the controller 318 may control the second compression stage 114 to compress the pretreated fluid stream 126 based on difference between the inlet pressure and the operational range of the regenerative unit 306. The second compression stage 114 may be controlled in near real-time to produce a compressed pretreated fluid stream 128. In some embodiments, the pressure of the pretreated fluid stream 126 may be within the operational range of the regenerative unit 306 and the second compression stage 114 may not further compress the pretreated fluid stream 126.

At block 412 of the process 400, the fluid purification system 100 may provide the pretreated fluid stream 126 to the regenerative unit 306. In some embodiments, the fluid purification system 100 may provide the compressed pretreated fluid stream 128 to the regenerative unit 306. The regenerative unit 306 may remove undesirable components from the pretreated fluid stream 126 and/or the compressed pretreated fluid stream 128 to generate a treated fluid stream 132. The treated fluid stream 132 may be further purified via the separation subsystem 106 of the fluid purification system 100. In some embodiments, the treated fluid stream 132 may be used to directly produce the methane-rich fluid 122.

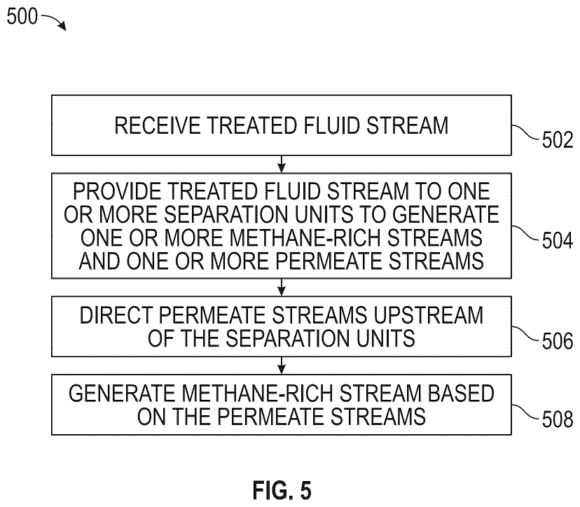

FIG. 5 is a flow diagram of a process 500 related to an embodiment of the recycle subsystem 304 of the fluid purification system 100 of FIG. 3, in accordance with an aspect of the present disclosure. The process 500 may be performed by a computing device, a controller, or any other suitable computing device(s) or controller(s). Furthermore, the blocks of the process 500 may be performed in the order disclosed herein or in any suitable order. For example, certain blocks of the process may be performed concurrently. In addition, in certain embodiments, at least one of the blocks of the process 500 may be omitted.

At block 502 of the process 500, the fluid purification system 100 may receive the treated fluid stream 132. At block 504 of the process 500, the fluid purification system 100 may provide the treated fluid stream 132 to one or more separation units 134. The one or more separation units 134 may include the VOC polishing bed 308, the first membrane separation unit 310, the second membrane separation unit 312. The separation units 134 may further purify the treated fluid stream 132 to generate the methane-rich fluid 122. The separation units 134 may generate one or more permeate streams 138. The permeate streams 138 may be output to the recycle subsystem 304 for further processing.

At block 506 of the process 500, the fluid purification system 100 may direct the permeate streams 138 upstream of the separation units 134. In some embodiments, the second permeate recycle stream 344 of the permeate streams 138 may be compressed by the recycle compression stage 314 prior to receival by the separation units 134. The second permeate recycle stream 344 of the permeate streams 138 may be directed to the VOC polishing bed 308. At block 508 of the process 500, the fluid purification system 100 may generate a methane-rich stream based on the permeate streams 138. That is, the separation units 134 may further process the permeate streams 138 that may include the second permeate recycle stream 344 to produce the methane-rich product stream. In some embodiments, the permeate recycle stream 344 may be combined with the treated fluid stream 132 for further purification. Alternatively, the permeate recycle stream 344 may be directed to the separation units 134 without combining with the treated fluid stream 132.

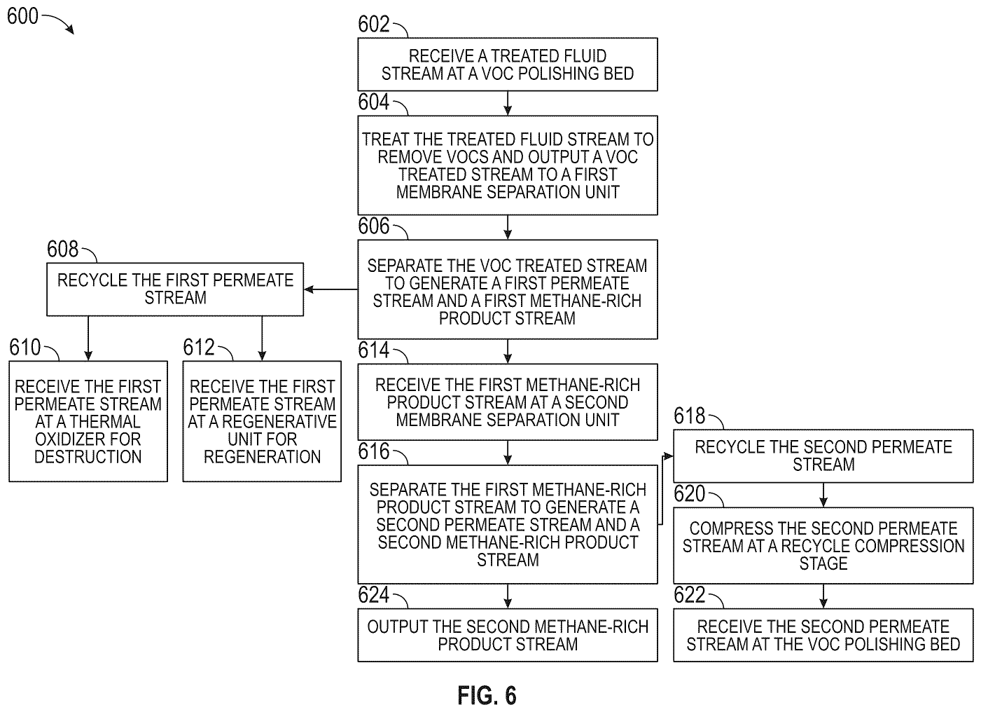

FIG. 6 is a flow diagram of a process 600 related to an embodiment of the recycle subsystem 304 of the fluid purification system of FIG. 3 including the first membrane separation unit 310 and the second membrane separation unit 312, in accordance with an aspect of the present disclosure. The process 600 may be performed by a computing device, a controller, or any other suitable computing device(s) or controller(s). Furthermore, the blocks of the process 600 may be performed in the order disclosed herein or in any suitable order. For example, certain blocks of the process may be performed concurrently. In addition, in certain embodiments, at least one of the blocks of the process 600 may be omitted.

At block 602 of the process 600, the fluid purification system 100 may receive a treated fluid stream 132 at a VOC polishing bed 308. At block 604 of the process 600, the fluid purification system 100 may treat the treated fluid stream 132 to remove VOCs and output a VOC treated stream 336 to a first membrane separation unit 310. The VOC polishing bed 308 may remove hydrocarbons, alcohols, amines, ethers, and the like. In some embodiments, the VOC treated stream 336 may be received by a heat exchanger 309. The heat exchanger 309 may heat the VOC treated stream 336 to generate a heated VOC treated stream 337. At block 606 of the process 600, the fluid purification system 100 may separate the VOC treated stream 336 to generate a first permeate stream 340 (e.g., a first permeate recycle stream) and a first methane-rich stream 338. In some embodiments, the fluid purification system 100 may separate the heated VOC treated stream 337 to generate a first permeate stream 340 and a first methane-rich stream 338. At block 608, the fluid purification system 100 may direct the first permeate stream 340 to a thermal oxidizer for destruction.. In some embodiments, the process 600 may proceed to block 610. At block 610, the fluid purification system 100 may receive the first permeate stream 340 at a thermal oxidizer for destruction. Additionally and/or alternatively, the process 600 may proceed from block 608 to the block 612. At block 612, the fluid purification system 100 may receive the first permeate stream 340 to at the regenerative unit 306 for regeneration of the regenerative unit 306.

Returning to block 606 of the process 600, the methane-rich product stream may be output to a second membrane separation unit 312. At block 614 of the process 600, the fluid purification system 100 may receive the first methane-rich stream 338 to the second membrane separation unit 312. At block 616 of the process 600, the fluid purification system 100 may separate the first methane-rich stream 338 to generate a second permeate stream 344 (e.g., a second permeate recycle stream) and a second methane-rich stream 342. The process 600 may proceed to block 618 to recycle the second permeate stream 344 at block 618. At block 620, the second permeate stream 344 may be compressed by a recycle compression stage 314 to generate a compressed second permeate stream 350. At block 622 of the process 600, the fluid purification system 100 may receive the compressed second permeate stream 350 at the VOC polishing bed 308. At block 624 of the process 600, fluid purification system 100 may output the second methane-rich stream 342. The second methane-rich stream 342 may be directed to additional purification steps before introduction into a renewal natural gas source.

Technical effects of the disclosed embodiments include a fluid purification system 100 for recycling one or more permeate streams 138 generated from one or more membrane separation units 310, 312 to produce a methane-rich fluid 122. In certain embodiments, the fluid purification system 100 disclosed herein may improve recyclability of treated streams and improve efficiency during generation of a methane-rich product stream. The fluid purification system 100 includes one or more purification substages to facilitate removal of one or more undesirable components from a feed stream. Advantageously, by controlling a recycle subsystem 304 of the fluid purification system 100 recyclability of treated streams into various positions within the fluid purification system may be controlled in response to changes or demands for landfill gas treatment, thereby helping to improve operations of the fluid purification system 100. Further, a pretreatment subsystem 102 of the fluid purification system 100 may include a hydrogen sulfide removal unit 302 that may operate at sufficiently high pressures to reduce pressure drop across the fluid purification system during pretreatment. The disclosed techniques may result in improved efficiency of feed stream purification to produce a methane-rich product stream by integrating the recycle subsystem 304 and/or the hydrogen sulfide removal unit 302 into the fluid purification system 100.

Having described various systems and methods herein, certain embodiments can include, but are not limited to:

Having described various systems and methods herein, certain embodiments can include, but are not limited to:
In a first aspect, a system comprises: a regenerative unit configured to receive a compressed fluid stream and generate a treated fluid stream based on the compressed fluid stream; one or more membrane separation units configured to generate a methane-rich stream and a permeate recycle stream based on the treated fluid stream; and a volatile organic compounds (VOC) polishing bed configured to receive the permeate recycle stream and remove organic compounds from the permeate recycle stream to generate a VOC treated stream, wherein the system is configured to route the VOC treated stream from the VOC polishing bed downstream of the regenerative unit.
A second aspect can include the system of the first aspect, wherein the system is configured to combine and pass the treated fluid stream to the VOC polishing bed with the permeate recycle stream as a combined stream to produce the VOC treated stream, wherein the one or more membrane separation units are configured to receive the VOC treated stream and generate the methane rich stream and the permeate recycle stream from the combined stream.
A third aspect can include the system of the first or second aspect, wherein the VOC polishing bed is positioned upstream of the one or more membrane separation units and downstream of the regenerative unit and wherein the system is configured to route the VOC treated stream downstream of the VOC polishing bed to the one or more membrane separation units.
A fourth aspect can include the system of any one of the proceeding aspects, wherein system is configured to route the permeate recycle stream to the VOC polishing bed and configured to route the VOC treated stream upstream of the one or more membrane separation units.
A fifth aspect can include the system of any one of the proceeding aspects, comprising a compressor configured to receive the permeate recycle stream from the one or more membrane separation units and compress the permeate recycle stream.
A sixth aspect can include the system of any one of the proceeding aspects, wherein the one or more membrane separation units comprise a first membrane separation unit and a second membrane separation unit, wherein the VOC polishing bed is configured to receive the compressed permeate recycle stream from the second membrane separation unit.
A seventh aspect can include the system of any one of the proceeding aspects, wherein the one or more membrane separation units are configured to route a portion of the permeate recycle stream to the regenerative unit.
An eighth aspect can include the system of any one of the proceeding aspects, wherein the regenerative unit and the one or more membrane separation units are fluidly coupled via a first flow path, and wherein the one or more membrane separation units and the VOC polishing bed are fluidly coupled via a second flow path that is different than the first flow path.
A ninth aspect can include the system of any one of the proceeding aspects, wherein the one or more membrane separation units comprise at first membrane separation unit and a second membrane separation unit, wherein the VOC polishing bed is configured to receive the permeate recycle stream from the first membrane separation unit.
A tenth aspect can include the system of any one of the proceeding aspects, further comprising a compression unit configured to receive a feed stream and to generate the compressed fluid stream.
In an eleventh aspect, a process for fluid purification comprises: feeding a first feed stream into a first feed compression unit, wherein the first feed compression unit is configured to compress the first feed stream to a first pressure generating a first compressed feed stream; feeding the first compressed feed stream into a hydrogen sulfide removal unit configured to remove a portion of hydrogen sulfide from the first compressed feed stream and to generate a pretreated fluid stream; feeding the pretreated fluid stream into a second feed compression unit configured to receive the pretreated fluid stream and to generate a second compressed fluid stream at a second pressure; feeding the second compressed fluid stream into a regenerative unit configured to generate a waste gas stream and a treated fluid stream; feeding the treated fluid stream into a volatile organic carbons (VOC) polishing bed configured to generate a VOC treated stream; feeding the VOC treated stream into one or more membrane separation units configured to generate a methane-rich stream and one or more permeate recycle streams; and feeding one or more permeate recycle streams via, a flow path, to a position upstream of the VOC polishing bed and downstream of the regenerative unit.
A twelfth aspect can include the process of the eleventh aspect, comprising: feeding the VOC treated stream into a first membrane separation units of the one or more membrane separation units configured to generate a first permeate stream of the one or more permeate recycle streams and a first methane-rich stream; and feeding the first methane-rich stream into a second membrane separation units of the one or more membrane separation units configured to generate a second permeate stream of the one or more permeate recycle streams and a second methane-rich stream.
A thirteenth aspect can include the process of the eleventh or twelfth aspect, comprising feeding the second permeate stream into a recycle compression unit configured to receive and compress the permeate stream, and feeding the compressed permeate stream into the VOC polishing bed.
A fourteenth aspect can include the process of any one of the eleventh to thirteenth aspects, comprising: feeding the one or more permeate recycle streams into a recycle compression unit configured to receive and compress the one or more permeate recycle streams, and feeding the one or more compressed permeate recycle streams into additional VOC polishing bed configured generate a second VOC treated stream, based on the one or more permeate streams.
A fifteenth aspect can include the process of any one of the eleventh to fourteenth aspects, wherein the additional VOC polishing bed is positioned on a bypass flow path, and wherein the bypass flow path is independent of the regenerative unit and the VOC polishing bed.
A sixteenth aspect can include the process of any one of the eleventh to fifteenth aspects, wherein the feed stream comprises methane, carbon dioxide, hydrogen sulfide, oxygen, nitrogen, hydrogen, volatile organic compounds, or a combination thereof.
In a seventeenth aspect, a system comprises: a first compression unit configured to receive a feed stream and to compress the feed stream to a first pressure, wherein the first pressure is between 10 and 100 psig; a hydrogen sulfide removal unit configured to receive the compressed feed stream and to generate a pretreated fluid stream; a second compression unit configured to receive the pretreated fluid stream and to compress the pretreated fluid stream to a second pressure that is greater than the first pressure; and a regenerative unit configured to receive the pretreated fluid stream compressed to the second pressure and generate a treated fluid stream.
An eighteenth aspect can include the system of the seventeenth aspect, further comprising: a volatile organic carbons (VOC) polishing bed configured to receive the treated fluid stream and generate a VOC treated stream; one or more membrane separation units configured to generate a methane-rich stream and one or more permeate recycle streams based on the compressed fluid stream; and a flow path configured to provide the one or more permeate recycle streams to a position upstream of the VOC polishing bed and downstream of the regenerative unit.
A nineteenth aspect can include the system of the seventeenth or eighteenth aspect, wherein the hydrogen sulfide removal unit comprises a non-regenerative adsorption media.
In a twentieth aspect, a system comprises: a pretreatment subsystem configured to receive a methane-containing feed stream and generate a compressed pretreated stream based on the methane-containing feed stream; a regenerative adsorption subsystem configured to receive the compressed pretreated stream and generate a treated fluid stream based on the compressed pretreated stream; a separation subsystem configured to receive the treated fluid stream along a first flow path, and wherein the separation subsystem is configured to generate a permeate recycle stream and a methane-rich fluid based on the treated fluid stream; and a recycle subsystem configured to receive the permeate recycle stream, wherein the recycle subsystem comprises a second flow path that includes the permeate recycle stream and is directed into the first flow path at a position downstream of the regenerative adsorption subsystem with respect to the first flow path.
A twenty first aspect can include the system of the twentieth aspect, wherein the separation subsystem comprises a VOC polishing bed, wherein the second flow path is directed into the first flow path at the position downstream of the regenerative adsorption subsystem and upstream of the VOC polishing bed with respect to the first flow path.
A twenty second aspect can include the system of the twentieth or twenty first aspect, wherein the recycle subsystem comprises a VOC polishing bed configured to receive the permeate recycle stream and generate a recycle treated stream along the second flow path.

While preferred embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

Also, techniques, systems, subsystems, and methods described and illustrated in the various implementations as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

Each and every claim is incorporated into the specification as an aspect of the present disclosure. Thus, the claims are a further description and are an addition to the aspects of the present disclosure. The discussion of a reference herein is not an admission that it is prior art to the presently disclosed subject matter, especially any reference that may have a publication date after the priority date of this application. The disclosures of all patents, patent applications, and publications cited herein are hereby incorporated by reference, to the extent that they provide exemplary, procedural or other details supplementary to those set forth herein. In the event of conflict, the present specification, including definitions, is intended to control.

What is claimed is:

1. A system, comprising:
a regenerative unit configured to receive a compressed fluid stream and generate a treated fluid stream based on the compressed fluid stream;
one or more membrane separation units configured to generate a methane-rich stream and a permeate recycle stream based on the treated fluid stream; and
a volatile organic compounds (VOC) polishing bed configured to receive the permeate recycle stream and remove organic compounds from the permeate recycle stream to generate a VOC treated stream, wherein the system is configured to route the VOC treated stream from the VOC polishing bed downstream of the regenerative unit.

2. The system of claim 1, wherein the system is configured to combine and pass the treated fluid stream to the VOC polishing bed with the permeate recycle stream as a combined stream to produce the VOC treated stream, wherein the one or more membrane separation units are configured to receive the VOC treated stream and generate the methane rich stream and the permeate recycle stream from the combined stream.

3. The system of claim 1, wherein the VOC polishing bed is positioned upstream of the one or more membrane separation units and downstream of the regenerative unit and wherein the system is configured to route the VOC treated stream downstream of the VOC polishing bed to the one or more membrane separation units.

4. The system of claim 1, wherein system is configured to route the permeate recycle stream to the VOC polishing bed and configured to route the VOC treated stream upstream of the one or more membrane separation units.

5. The system of claim 4, comprising a compressor configured to receive the permeate recycle stream from the one or more membrane separation units and compress the permeate recycle stream.

6. The system of claim 5, wherein the one or more membrane separation units comprise a first membrane separation unit and a second membrane separation unit, wherein the VOC polishing bed is configured to receive the compressed permeate recycle stream from the second membrane separation unit.

7. The system of claim 1, wherein the one or more membrane separation units are configured to route a portion of the permeate recycle stream to the regenerative unit.

8. The system of claim 1, wherein the regenerative unit and the one or more membrane separation units are fluidly coupled via a first flow path, and wherein the one or more membrane separation units and the VOC polishing bed are fluidly coupled via a second flow path that is different than the first flow path.

9. The system of claim 1, wherein the one or more membrane separation units comprise at first membrane separation unit and a second membrane separation unit, wherein the VOC polishing bed is configured to receive the permeate recycle stream from the first membrane separation unit.

10. The system of claim 1, further comprising a compression unit configured to receive a feed stream and to generate the compressed fluid stream.

11. A process for fluid purification, the process comprising:
feeding a first feed stream into a first feed compression unit, wherein the first feed compression unit is configured to compress the first feed stream to a first pressure generating a first compressed feed stream;
feeding the first compressed feed stream into a hydrogen sulfide removal unit configured to remove a portion of hydrogen sulfide from the first compressed feed stream and to generate a pretreated fluid stream;
feeding the pretreated fluid stream into a second feed compression unit configured to receive the pretreated fluid stream and to generate a second compressed fluid stream at a second pressure;
feeding the second compressed fluid stream into a regenerative unit configured to generate a waste gas stream and a treated fluid stream;
feeding the treated fluid stream into a volatile organic carbons (VOC) polishing bed configured to generate a VOC treated stream;
feeding the VOC treated stream into one or more membrane separation units configured to generate a methane-rich stream and one or more permeate recycle streams; and
feeding one or more permeate recycle streams via, a flow path, to a position upstream of the VOC polishing bed and downstream of the regenerative unit.

12. The process of claim 11, comprising:
feeding the VOC treated stream into a first membrane separation units of the one or more membrane separation units configured to generate a first permeate stream of the one or more permeate recycle streams and a first methane-rich stream; and
feeding the first methane-rich stream into a second membrane separation units of the one or more membrane separation units configured to generate a second permeate stream of the one or more permeate recycle streams and a second methane-rich stream.

13. The process of claim 12, comprising feeding the second permeate stream into a recycle compression unit configured to receive and compress the permeate stream, and feeding the compressed permeate stream into the VOC polishing bed.

14. The process of claim 11, comprising:
feeding the one or more permeate recycle streams into a recycle compression unit configured to receive and compress the one or more permeate recycle streams, and feeding the one or more compressed permeate recycle streams into additional VOC polishing bed configured generate a second VOC treated stream, based on the one or more permeate streams.

15. The process of claim 14, wherein the additional VOC polishing bed is positioned on a bypass flow path, and wherein the bypass flow path is independent of the regenerative unit and the VOC polishing bed.

16. The process of claim 11, wherein the feed stream comprises methane, carbon dioxide, hydrogen sulfide, oxygen, nitrogen, hydrogen, volatile organic compounds, or a combination thereof.

17. A system comprising:
a first compression unit configured to receive a feed stream and to compress the feed stream to a first pressure, wherein the first pressure is between 10 and 100 psig;
a hydrogen sulfide removal unit configured to receive the compressed feed stream and to generate a pretreated fluid stream;
a second compression unit configured to receive the pretreated fluid stream and to compress the pretreated fluid stream to a second pressure that is greater than the first pressure; and
a regenerative unit configured to receive the pretreated fluid stream compressed to the second pressure and generate a treated fluid stream.

18. The system of claim 17, further comprising:
a volatile organic carbons (VOC) polishing bed configured to receive the treated fluid stream and generate a VOC treated stream;
one or more membrane separation units configured to generate a methane-rich stream and one or more permeate recycle streams based on the compressed fluid stream; and
a flow path configured to provide the one or more permeate recycle streams to a position upstream of the VOC polishing bed and downstream of the regenerative unit.

19. The system of claim 17, wherein the hydrogen sulfide removal unit comprises a non-regenerative adsorption media.

20. A system, comprising:
a pretreatment subsystem configured to receive a methane-containing feed stream and generate a compressed pretreated stream based on the methane-containing feed stream;
a regenerative adsorption subsystem configured to receive the compressed pretreated stream and generate a treated fluid stream based on the compressed pretreated stream;
a separation subsystem configured to receive the treated fluid stream along a first flow path, and wherein the separation subsystem is configured to generate a permeate recycle stream and a methane-rich fluid based on the treated fluid stream; and
a recycle subsystem configured to receive the permeate recycle stream, wherein the recycle subsystem comprises a second flow path that includes the permeate recycle stream and is directed into the first flow path at a position downstream of the regenerative adsorption subsystem with respect to the first flow path.

21. The system of claim 20, wherein the separation subsystem comprises a VOC polishing bed, wherein the second flow path is directed into the first flow path at the position downstream of the regenerative adsorption subsystem and upstream of the VOC polishing bed with respect to the first flow path.

22. The system of claim 20, wherein the recycle subsystem comprises a VOC polishing bed configured to receive the permeate recycle stream and generate a recycle treated stream along the second flow path.
